(19) United States
(12) Patent Application Publication
(10) Pub. No.: US 2012/0210301 A1
(43) Pub. Date: Aug. 16, 2012

(54) METHOD, SYSTEM AND APPARATUS FOR MANAGING THE RE-USE OF SOFTWARE REQUIREMENTS

(75) Inventor: Martin CRISP, Toronto (CA)

(73) Assignee: BLUEPRINT SOFTWARE SYSTEMS INC., Toronto (CA)

(21) Appl. No.: 13/370,848

(22) Filed: Feb. 10, 2012

Related U.S. Application Data
(60) Provisional application No. 61/441,917, filed on Feb. 11, 2011.

(51) Int. Cl. G06F 9/44

(52) U.S. Cl. 717/120

(57) ABSTRACT

According to embodiments described in the specification, a method, system and apparatus for managing software requirements is provided. The method comprises storing a source descriptor in a memory in association with a first module, the descriptor comprising a requirement for a proposed software application; receiving a request for the source descriptor; and creating and storing, responsive to the request, a subscribing descriptor, the subscribing descriptor being a copy of the source descriptor and including an identifier of the source descriptor, the subscribing descriptor being stored in the memory in association with a second module.

### FIELD

The specification relates generally to software design, and specifically to a method, system and apparatus for managing software requirements and the re-use thereof.

### BACKGROUND

Even as computing technology increases its sophistication and reach across broader ranges of the population, in many circumstances the approaches to software development have not kept pace with the computing technology itself.

### BRIEF DESCRIPTIONS OF THE DRAWINGS

Embodiments are described with reference to the following figures, in which:

FIG. 1 depicts a system for managing data, according to a non-limiting embodiment;

FIG. 2 depicts a method of managing descriptors, according to a non-limiting embodiment;

FIG. 3 depicts a source descriptor managed by the system of FIG. 1, according to a non-limiting embodiment;

FIG. 4 depicts a subscribing descriptor managed by the system of FIG. 1, according to a non-limiting embodiment;

FIG. 5 depicts a modified version of the source descriptor of FIG. 3, according to a non-limiting embodiment;

FIG. 6 depicts an interface generated during the performance of the method of FIG. 2, according to a non-limiting embodiment;

FIG. 7 depicts a modified version of the subscribing descriptor of FIG. 4, according to a non-limiting embodiment;

FIG. 8 depicts a method of managing descriptors, according to another non-limiting embodiment;

FIG. 9 depicts another modified version of the subscribing descriptor of FIG. 4, according to a non-limiting embodiment; and

FIG. 10 depicts a method of performing block 827 of FIG. 8, according to a non-limiting embodiment.

### DETAILED DESCRIPTION OF THE EMBODIMENTS

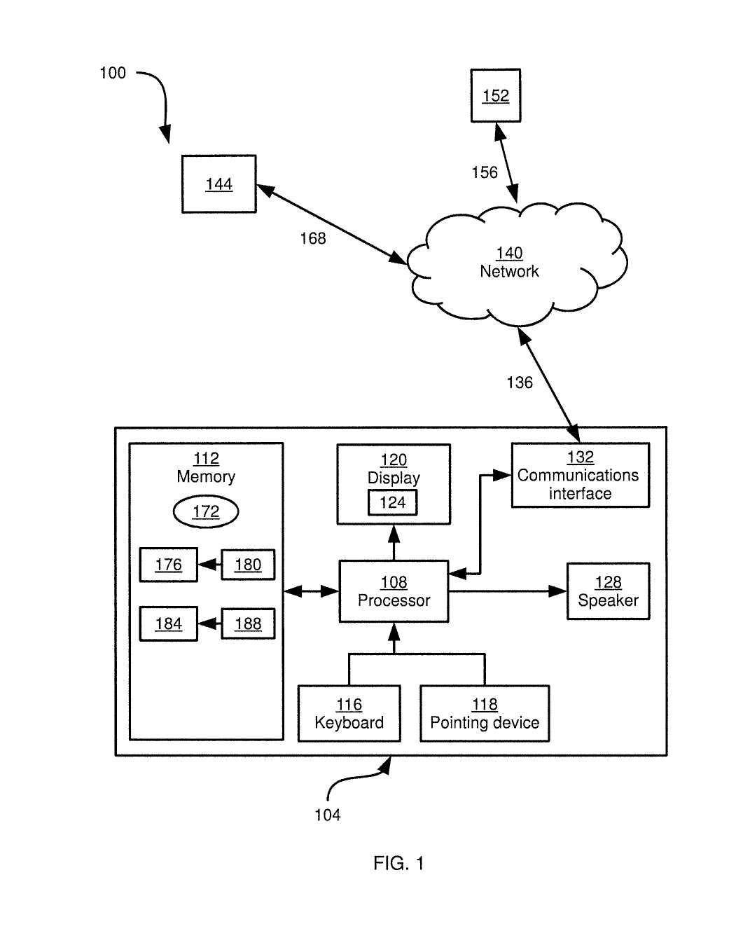

FIG. 1 depicts a system 100 for managing data, and in particular data defining software requirements. System 100 includes a computing device 104, which can be based on any known computing environment. In the present example embodiment, computing device 104 (also referred to herein simply as “computer 104”) is a desktop computer. It is contemplated, however, that in other embodiments, computing device 104 can comprise a server, a collection of servers (i.e. a cloud computing environment), a tablet computer, a laptop computer and the like.

Computer 104 thus includes a processor 108 interconnected with a non-transitory computer readable storage medium such as a memory 112. Memory 112 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. Computer 104 also includes one or more input devices interconnected with processor 108. Such input devices are configured to receive input and provide input data representative of the received input to processor 108. Input devices can include, for example, a keyboard 116 and a pointing device 118, such as a mouse. It is contemplated that computer 104 can include additional input devices in the form of one or more touch screens, light sensors, microphones and the like (not shown). In general, it is contemplated that any suitable combination of the above-mentioned input devices can be connected to processor 108 of computer 104.

Computer 104 also includes one or more output devices interconnected with processor 108. The output devices of computer 104 include a display 120. Display 120 includes display circuitry 124 controllable by processor 108 for generating interfaces which include representations of data maintained in memory 112. Display 120 can include either or both of a cathode ray tube (CRT) display and a flat panel display comprising any suitable combination of a Liquid Crystal Display (LCD), a plasma display, an Organic Light Emitting Diode (OLED) display, and the like. Circuitry 124 can thus include any suitable combination of display buffers, transistors, electron guns, LCD cells, plasma cells, phosphors, LEDs and the like. In embodiments that include a touch screen input device, the touch screen can be integrated with display 120.

The output devices of computer 104 can also include a speaker 128 interconnected with processor 108. Additional output devices can also be included.

Computer 104 also includes a communications interface 132 interconnected with processor 108. Communications interface 132 is a network interface controller (MC) which allows computer 104 to communicate with other computing devices via a link 136 and a network 140. Network 140 can include any suitable combination of wired and/or wireless networks, including but not limited to a Wide Area Network (WAN) such as the Internet, a Local Area Network (LAN), cell phone networks, WiFi networks, WiMax networks and the like. Link 136 is compatible with network 140. In the present example embodiment, link 136 is a wired link. In some embodiments, however, link 136 can be a wireless link based on, for example, Institute of Electrical and Electronic Engineers (IEEE) 802.11 (WiFi) or other wireless protocols. It is contemplated that other wireless standards (Global System for Mobile communications (GSM), General Packet Radio Service (GPRS), Enhanced Data rates for GSM Evolution (EDGE), the third and fourth-generation mobile communication system (3G and 4G) and the like) can also be employed.

The various components of computer 104 are interconnected, for example via a communication bus (not shown). Computer 104 can be supplied with electricity by a wired connection to a wall outlet or other power source.

System 100 can also include other computing devices, such as a personal computer 144 coupled to network 140 via a wired link 148, as well as a mobile device (e.g. a smartphone) 152 coupled to network 140 via a wireless link 156. It is contemplated that additional computing devices (not shown) of various types can also be connected to network 140 via respective wired or wireless links.

Computer 104 stores, in memory 112, a simulation application 172, comprising a set of computer-readable instructions executable by processor 108. Processor 108, via execution of the instructions of application 172, is configured to carry out various functions related to the generation of specifications for a proposed software application. In general, processor 108 is configured to receive descriptors, each descriptor comprising data which identifies one or more aspects or attributes of the proposed software application. Processor 108 is also configured to receive pointers identifying relationships between the various descriptors. Processor 108 can also be configured to automatically determine additional relationships between descriptors, and to create a simulation of the proposed software application based on the received descriptors and relationships (both received and automatically determined).

It is contemplated that specifications can be generated using simulation application 172 for multiple versions of a proposed software application, as well as for different proposed software applications, whether related to each other or not. As will be discussed below in greater detail, processor 108 is therefore also configured to manage the received descriptors for use in simulations in a single proposed application, as well as between versions of a proposed application and in different proposed applications.

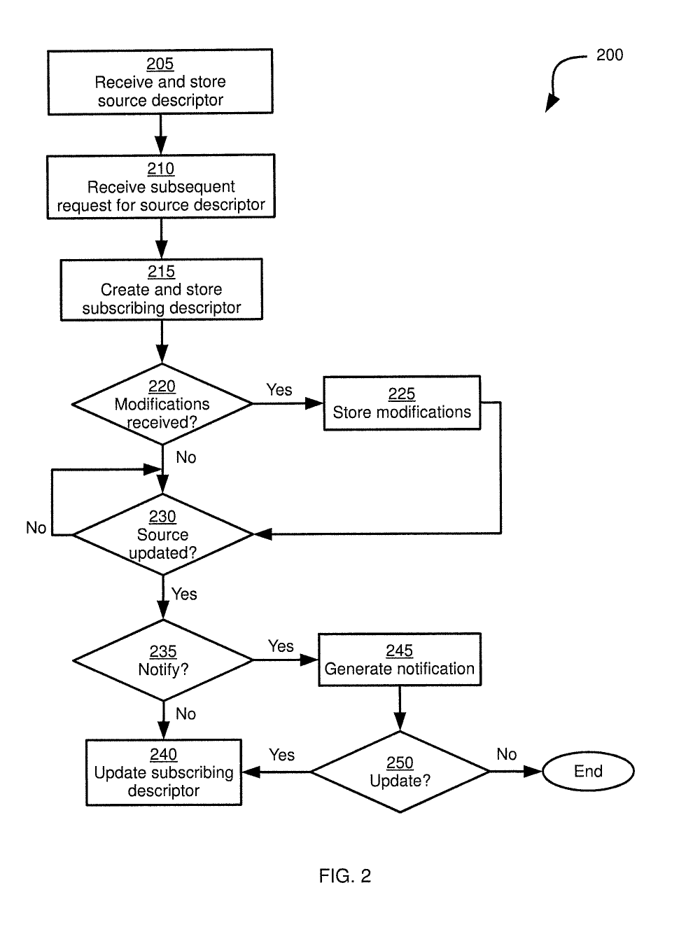

Turning to FIG. 2, a method 200 of managing descriptors is depicted. Method 200 will be described in conjunction with its performance on system 100. Thus, the blocks of method 200 are performed by processor 108 as configured via execution of simulation application 172, and in conjunction with the other components of computer 104. It is contemplated that method 200 can also be performed on any suitable system, as will now be apparent to those skilled in the art.

At block 205, processor 108 is configured to receive a “source” descriptor and to store the descriptor in memory 112 in connection with a first module. The term “module” as used herein refers broadly to a collection of descriptors and other data (including, for example, relationship pointers) stored in memory 112, to be used by processor 108 executing simulation application 172. In the present example performance of method 200, the first module encompasses the descriptors and other data which define a user portal for a proposed airline booking management software application (i.e. the interfaces and functions accessible by an employee at a customer service counter). Thus, other modules, as will be seen below, can contain data which defines other portions (such as an administrator portal) of the same proposed application. It is contemplated that in other embodiments, a module can be considered to encompass the entirety of the data which defines a proposed software application, as opposed to a portion of the proposed application as in the example above.

Referring briefly to FIG. 1, a first module 176 is shown in memory 112, comprising descriptors and other data defining the above-mentioned user portal. A descriptor 180 is also shown, corresponding to the descriptor received at block 205 of method 200. As mentioned above, descriptor 180 is also referred to herein as a source descriptor. Source descriptor 180 can be stored in memory 112 separately from module 176 or within module 176. If source descriptor 180 is stored separately from module 176, module 176 can contain references to source descriptor 180 (and indeed to all descriptors considered to form part of module 176).

Returning to FIG. 2, source descriptor 180 can be received by processor 108 in a variety of manners. In the present example embodiment, source descriptor 180 is received from keyboard 116 in the form of input data representative of input at keyboard 116. In other embodiments, descriptor 180 can be received at processor 108 from other input devices, or from a different computing device (such as personal computer 144) via network 140 and communications interface 132.

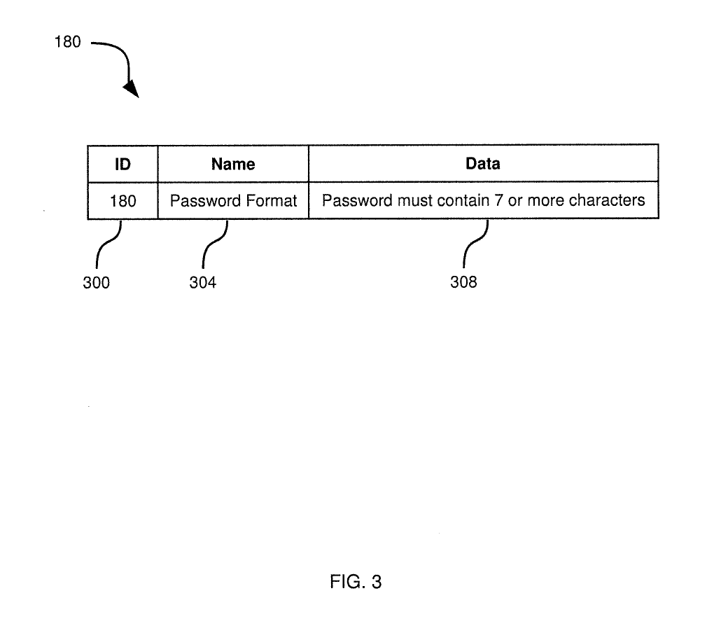

Referring now to FIG. 3, source descriptor 180 is depicted as stored in memory 112. It will be understood that while source descriptor 180 is shown in tabular format, any suitable format can be used to store source descriptor 180. As can be seen from FIG. 3, source descriptor 180 describes a requirement for user passwords. In particular, source descriptor 180 establishes the requirement that passwords for accessing (i.e. logging into) the user portal defined by first module 176 must be at least seven characters in length. Source descriptor 180 includes a descriptor ID 300 (“180”) which can be assigned to source descriptor 180 by processor 108. Source descriptor 180 also includes a descriptor name 304 (“Password Format”) and a data field 308 containing data which defines the actual requirement. It is contemplated that source descriptor 180 can include additional fields (not shown), such as a timestamp indicating the time at which source descriptor 180 was created. Other additional fields which can be included in source descriptor 180 will become apparent through the discussion below.

Returning to FIG. 2, the performance of method 200 continues at block 210, at which processor 108 is configured to receive a subsequent request (that is, subsequent to the receipt of source descriptor 180) for source descriptor 180. The subsequent request can be received from one or more input devices of computer 104, or from another computing device, via network 140. The request can take various forms. In the present example performance of method 200, the request is a request to use source descriptor 180 in a different module than first module 176. The request thus includes descriptor identifier 300, and can also include, for example, an identifier of the second module with which the request is associated. In other embodiments, the request need not be made with specific relation to source descriptor 180. For example, the request can be a request for the second module to inherit all or a group of descriptors from first module 176. Such a request is considered a request for source descriptor 180 when source descriptor 180 falls within the group of descriptors to be inherited.

Following receipt of the request at block 210, the performance of method 200 proceeds to block 215, at which processor 108 is configured to create and store a copy of source descriptor 180 in memory 112 in connection with a second module. Returning to FIG. 1, a second module 184 is shown in memory 112, along with a subscribing descriptor 188. Subscribing descriptor 188, so named because it can be seen as subscribing to source descriptor 180, is the result of the creation and storage of a copy of source descriptor 180. Second module 184, in the present example performance of method 200, encompasses the descriptors and other data which define an administrator portal for the proposed airline booking management software application (i.e. the interfaces and functions accessible by an administrator, which will generally, although not necessarily, be a superset of those of the user portal). As mentioned earlier, in other embodiments second module 184 can instead encompass the data defining an entirely different proposed software application, or a different version of the same proposed application.

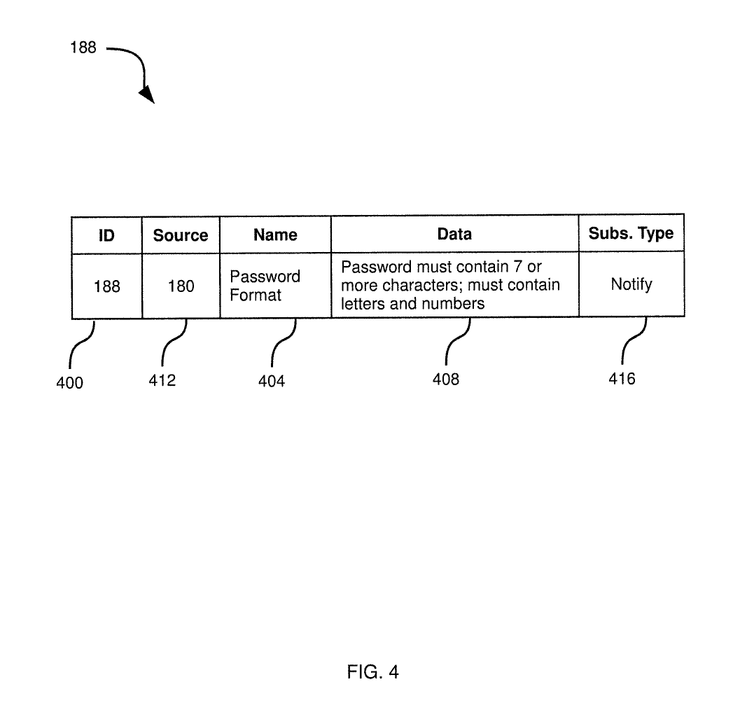

Turning to FIG. 4, subscribing descriptor 188 is shown as stored in memory 112. As noted above, the depicted tabular format is used for illustrative purposes, but is not a necessity. Subscribing descriptor 188 includes an identifier 400 which can be assigned by processor 108, a name 404 and data 408 defining the password format requirement. Subscribing descriptor 188 also includes a source field 412 which contains an identifier of the descriptor from which subscribing descriptor 188 was copied. In the present example performance of method 200, therefore, field 412 contains the identifier of source descriptor 180. It is also noted that data field 408 includes the contents of data field 308 of source descriptor. As will be discussed in greater detail below, subscribing descriptor 188 is considered to be linked (or subscribed) to source descriptor 180. The link is indicated by the contents of the source field 412.

Referring again to FIG. 2, the performance of method 200 continues at block 220, at which processor 108 is configured to determine whether any modifications to subscribing descriptor 188 have been received. Such modifications can be received as input data from the input devices of computer 104, or from other computing devices. In addition, such modifications can be received substantially simultaneously with, or immediately after creation of subscribing descriptor 188, or at a later time, or any combination of the above. In the present example performance of method 200, it will be assumed that the determination at block 220 is affirmative as a result of modifications to subscribing descriptor 188 received shortly (e.g. 30 seconds) after the creation of subscribing descriptor 188.

Upon an affirmative determination at block 220, the performance of method 200 proceeds to block 225, at which subscribing descriptor 188 is updated in memory 112. Referring again to FIG. 4, attention is directed to data field 408, which includes the contents of data field 308 as well as additional data. In particular, data field 408 also includes the requirement that a password must contain both letters and numbers. Thus, subscribing descriptor 188 defines a requirement that is based on source descriptor 180, but imposes an additional criterion (the presence of both letters and numbers). The data defining that additional criterion are received and stored in memory 112 at block 225.

Returning to FIG. 2, the performance of method 200 proceeds to block 230, at which processor 108 is configured to determine whether source descriptor 180 has been updated (that is, whether any changes to the requirement defined by source descriptor 180 have been made). In performing block 230, processor 108 can be configured to examine a time stamp (not shown) indicating the time when source descriptor 180 was last modified. In other embodiments, processor 108 can be configured to examine the “source” portion of data field 408 in subscribing descriptor 188 and compare that portion to data field 308 in order to determine if any changes have been made to data field 308. In other examples, rather than the examination of a time stamp, processor 108 can be configured to respond to updates to source descriptor 180 by searching memory 112 for any subscribing descriptors which subscribe to source descriptor 180 and performing blocks 235 and onwards for those subscribing descriptors. In other words, updates made to source descriptor 180 (for example, as a result of input data received from personal computer 144) can trigger the performance of blocks 235-250.

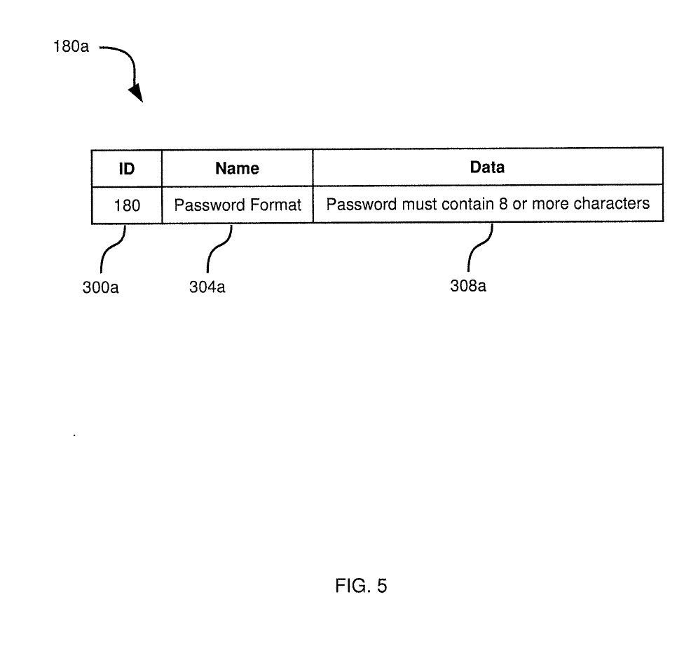

When the determination at block 230 is negative—that is, when no updates to source descriptor are detected by processor 108—processor 108 can be configured to “wait” at block 230, as shown in FIG. 2. It is contemplated, however, that processor 108 need not suspend other activities while waiting, including other performances of method 200 relating to other descriptors. In the present example performance of method 200, it will be assumed that source descriptor 180 has been modified. Referring now to FIG. 5, an updated version of source descriptor 180, identified by the reference 180a. Of note is that the data field 308a specifies that passwords must contain at least 8 characters, rather than at least 7 characters as shown in FIG. 3. Thus, returning to FIG. 2, the determination at block 230 will be affirmative.

When the determination at block 230 is affirmative, the performance of method 200 proceeds to block 235, at which processor 108 is configured to determine whether or not to generate a notification relating to the change in source descriptor 180. Processor 108 can be configured by way of a configurable setting provided by application 172 to always generate a notification, or to never generate a notification. In other embodiments, source descriptor 180 can include an indication of whether or not to generate notifications upon detection of updates. In still other embodiments, as in the present example embodiment, subscribing descriptor 188 can include an additional field—shown in FIG. 4 as field 416—indicating the type of subscription (also referred to as an update type or a subscription state indicator). The subscription type indicates whether notifications are to be generated when source descriptor 180 is updated. In the present example, two subscription types are contemplated: Notify, and Automatic. The Notify type (shown in FIG. 4) indicates that a notification is to be generated before subscribing descriptor 188 is updated in response to an update to source descriptor 180. The Automatic type indicates that updates to source descriptor 180 are to be applied automatically to subscribing descriptor, without the generation of notifications.

The subscription type can be set in a variety of ways. For example, the subscription type can be received explicitly as input data along with the request received at block 210, or can be received as input data at block 215 when subscribing descriptor 188 is created and stored. In other examples, the subscription type can be set automatically by processor 108 based on the nature of the request received at block 210. It is contemplated that there may exist multiple versions of source descriptor 180. The request received at block 210 can be a request to subscribe to the most recent version of source descriptor 180 (also referred to as the “tip”), or can be a request to subscribe to one particular version of source descriptor 180 (also referred to as a “historic version”). When the request is for the tip, subscription type 416 can be set to Automatic, and when the request is for a historic version, subscription type 416 can be set to Notify. It is also contemplated, however, that the subscription type can be changed via receipt of input data (for example, from personal computer 144) at any point during the performance of method 200.

When the determination at block 235 is negative, subscribing descriptor 188 is automatically updated with the modification to source descriptor 180 at block 240. When the determination at block 235 is affirmative, however, as in the present performance of method 200 in light of the contents of field 416, the performance of method 200 proceeds to block 245.

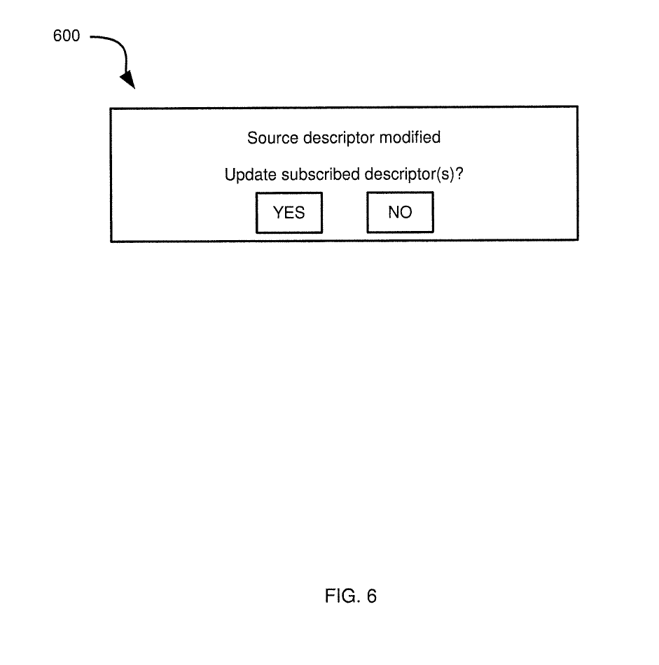

At block 245, processor 108 is configured to control one or more output devices such as display 120 (and in particular display circuitry 124) to generate a notification. An example notification 600 is shown in FIG. 6, as generated on display 120. Following generation of the notification at block 245, processor 108 is configured to determine whether to update subscribing descriptor 188 at block 250.

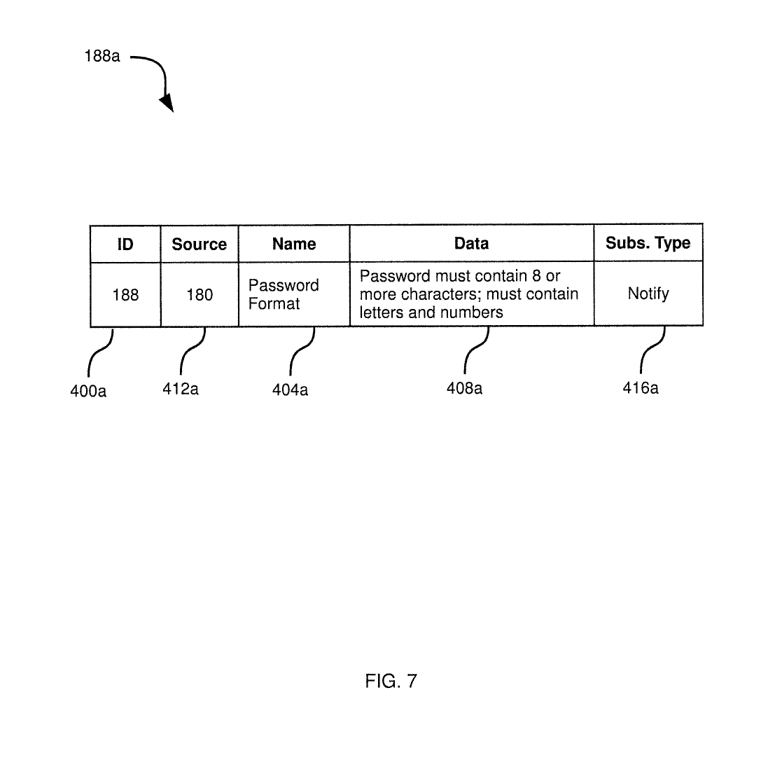

The determination at block 250 can be made based on an instruction received at processor 108, for example from pointing device 118, in response to the notification generated at block 245. For example, referring to FIG. 6, pointing device 118 can be used to select the “YES” element of notification 600, as a result of which pointing device 118 transmits input data representative of the selection to processor 108. Processor 108 then determines that subscribing descriptor 188 is to be updated and proceeds to block 240. Turning briefly to FIG. 7, an updated version 188a of subscribing descriptor 188 is shown, in which the contents of data field 408a have been updated based on the contents of data field 308a of the modified source descriptor 180a, while fields 400a, 404a, 412a and 416a remain unchanged. It is contemplated that while field 408a contains both the updated contents of field 308a and the modifications discussed in connection with block 220 of method 200, in other examples, modifications to subscribing descriptor 188 prior to the performance of block 240 can simply be discarded. That is, field 408a could contain only the data contained in field 308a, the earlier modifications to subscribing descriptor 188 having been discarded or overridden during the performance of block 240.

When the determination at block 250 is negative (for example, if the “NO” element of notification 600 is selected), processor 108 can be configured not to apply the modification of source descriptor 180 to subscribing descriptor 188.

It is contemplated that the performance of block 230 need not immediately follow the performance of blocks 220 or 225. For example, as mentioned earlier, performance of block 230 can be initiated at the time of modification of source descriptor 180, or when subscribing descriptor 188 is retrieved from memory (i.e. when second module 184 is accessed). Thus, blocks 230-250 can be performed independently of the remainder of method 200, based on when source descriptor 180 is modified or when subscribing descriptor 188 is accessed. It is also contemplated that there may be many descriptors which subscribe to source descriptor. Thus, blocks 230-250 can also be performed repeatedly for various subscribing descriptors such as subscribing descriptor 188.

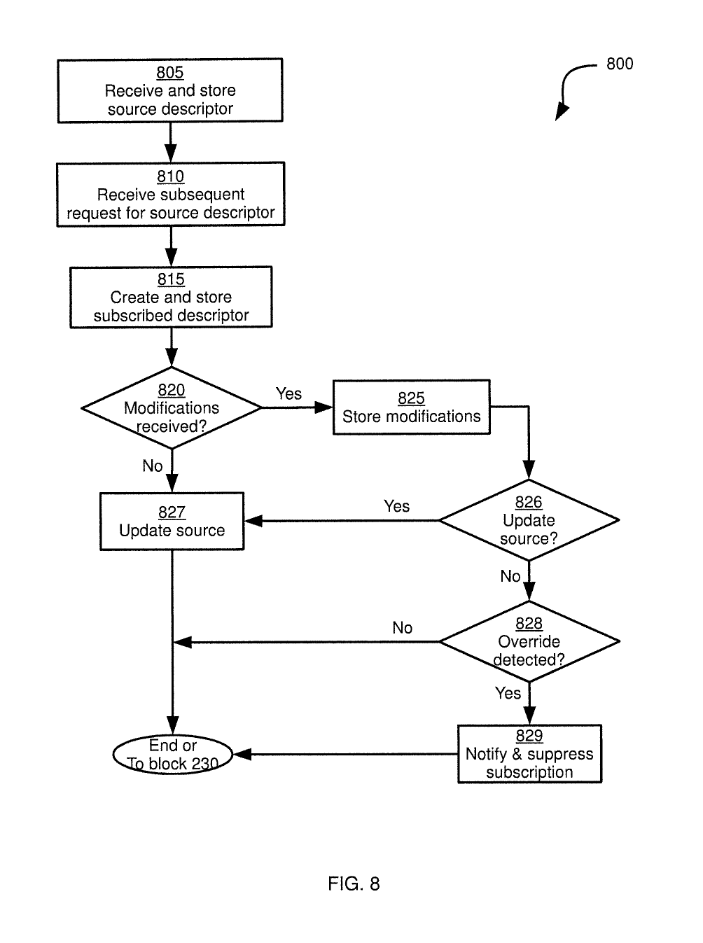

Referring now to FIG. 8, a method 800 of managing descriptors is depicted. Where the blocks of method 800 are similar to those of method 200, they are numbered similarly, with a leading “8” replacing the leading “2”. Thus, blocks 805, 810, 815, 820 and 825 of method 800 are as described above in connection with blocks 205, 210, 215, 220 and 225, respectively, of method 200.

Method 800 also includes additional blocks, which will be described below. It is contemplated that although the additional blocks of method 800 are shown separately from method 200, they can be incorporated with method 200 in some embodiments.

At block 826, having stored modifications to subscribing descriptor 188 as discussed above, processor 108 is configured to determine whether or not to update source descriptor 180 based on those modifications. The determination at block 826 involves determining whether an update instruction has been received, for example from an input device of computer 104. In some embodiments, an instruction to update source descriptor 180 can be generated automatically upon modification of subscribing descriptor 188. In the present example embodiment, an instruction is received at block 826 in the form of input data from one or both of keyboard 116 and pointing device 118. The instruction need not immediately follow the performance of block 825. In some examples, the determination at block 826 includes an authorization step, in which a notification is generated at a computing device associated with the author of source descriptor 180. Computer 104 can maintain an account database (not shown) including login credentials, permissions and other data for one or more accounts. The author of descriptor 180 is the account under which descriptor 180 was created. Thus, a notification can be generated at a computing device at which the author account is active, in response to updates being saved at block 825. The notification can be a prompt for an instruction to permit or deny an update to source descriptor 180. It is contemplate that some accounts can be permitted to authorize or deny source descriptor updates, while other accounts can be barred from doing so.

If the determination at block 826 is affirmative (that is, if an instruction to update source descriptor 180 is received), the performance of method 800 proceeds to block 827, at which source descriptor 180 is updated. The performance of block 827 will be described in greater detail below. Briefly, however, updating source descriptor 180 comprises temporarily reversing the source-subscriber relationship between descriptors. Thus, subscribing descriptor 188 (and any other subscribing descriptor s linked to source descriptor 180) temporarily becomes a source for source descriptor 180 in order to propagate the modifications stored at block 825 (and any modifications to other subscribing descriptors stored during other performances of block 825) back to source descriptor 180.

When the determination at block 826 is negative, the performance of method 800 proceeds to block 828, at which processor 108 is configured to determine whether any of the modifications received at block 825 for subscribing descriptor 188 override any attributes of source descriptor 180. Referring to FIG. 4, the additional requirements imposed by subscribing descriptor 188 (“must contain letters and numbers”) do not override the contents of data field 308 of source descriptor 180, but are instead complementary to data field 308. Thus the determination at block 828 is negative, and the performance of method 800 can end, or proceed to block 230, as described above.

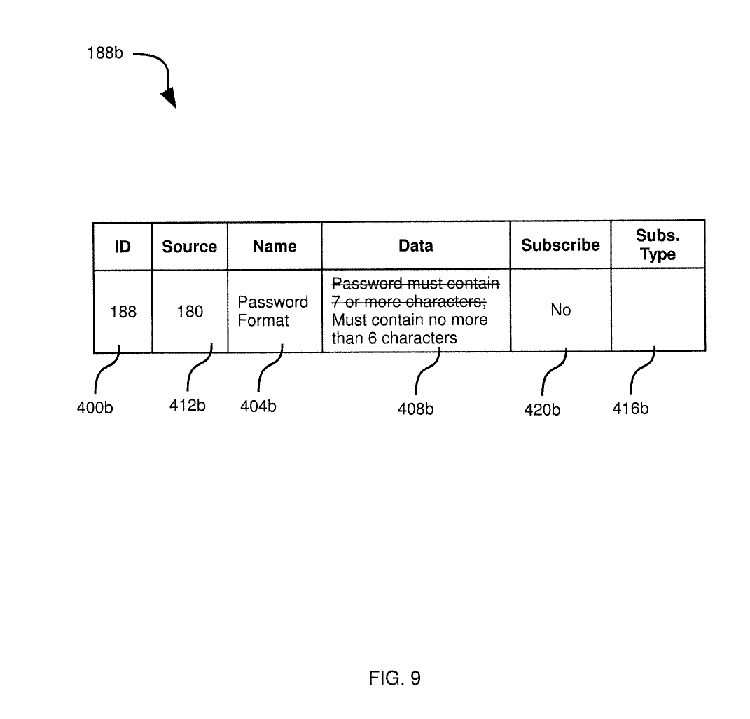

On the other hand, when the determination at block 828 is affirmative, the performance of method 800 proceeds to block 829. For example, if, in another embodiment, as shown in FIG. 9, subscribing descriptor 188 included in its data field 408 the condition that passwords contain a maximum of six characters, processor 108 would detect a conflict between source descriptor 180 and subscribing descriptor 188 (indicated by the strike-through of the original requirement in field 408b). Then, at block 829, processor 108 is configured to generate a notification on display 120 describing the conflict detected. Processor 108 is also configured to suppress the subscription to source descriptor 180. For example, referring to FIG. 9, this can be accomplished by adding a field 420b which indicates that although subscribing descriptor 188b is linked to source descriptor 180 (as indicated by field 412b), the subscription is currently not in use. When the contents of field 420b is “No”, the subscription is inactive and subscribing descriptor 188b will not be updated as a result of the performance of block 240 of method 200.

As seen in FIG. 9, the suppression of the subscription to source descriptor 180 can also include the deletion of the contents of field 416b. In some embodiments, however, rather than preventing updates at all and deleting the subscription type indicator 416b, the suppression of subscription could force a notification to be generated at block 235, regardless of the contents of field 416 of subscribing descriptor 188a (which can also be included in subscribing descriptor 188b). That is, “suppression” could be implemented by leaving or inserting a “Yes” in field 420b to indicate that the subscription is active, and updating the subscription type in field 416b to “Notify” even if it had previously been “Auto”.

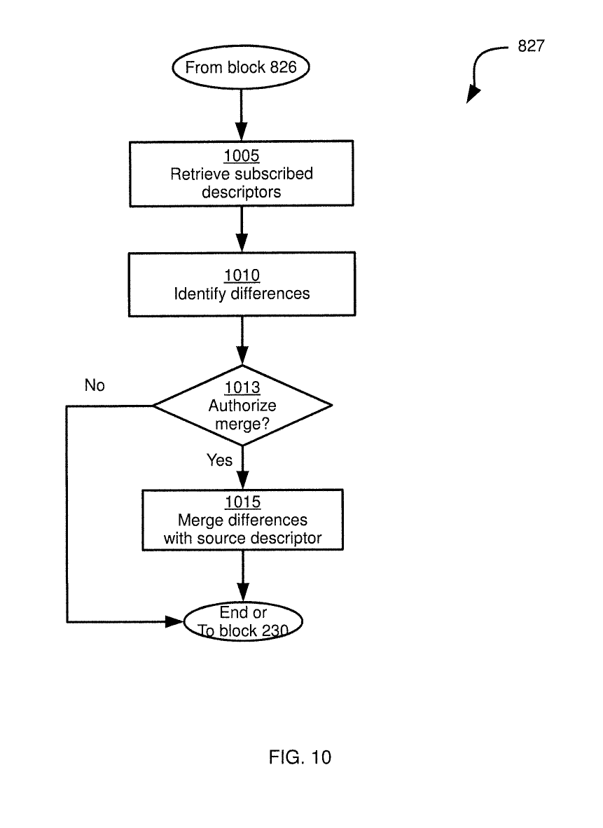

Turning now to FIG. 10, a more detailed depiction of the performance of block 827 is depicted. Beginning at block 1005, processor 108 is configured to retrieve all subscribing descriptors which subscribe to source descriptor 180. This can be accomplished by traversing the descriptors stored in memory 112 to locate those with the identifier “180” in source field 412. In other embodiments, performance of block 1005 can involve retrieving only those subscribing descriptors with, for example, a flag such as a “high priority” indicator (not shown).

Proceeding to block 1010, processor 108 is configured to identify the differences between the retrieved subscribing descriptors and the source descriptor. For example, the differences between subscribing descriptor 188 and source descriptor 180 include the requirement that a password contain both letters and numbers.

Proceeding then to block 1013, a determination can be made as to whether or not to authorize the merging of some or all of the differences identified at block 1010 with source descriptor 180. The authorization at block 1013 can be similar to that discussed above in connection with block 826, in that processor 108 can be configured to generate a prompt for an instruction to allow or deny the merging of one or more differences with source descriptor 180. As mentioned above, some accounts can be granted permission to authorize merging, while other accounts can be denied such permission. For accounts which are not permitted to authorize merging, the determination at block 1013 would automatically be negative.

If the determination at block 1013 is negative, performance of block 827 ends. If, on the other hand, the determination at block 1013 is affirmative, processor 108 then proceeds to block 1015, at which processor 108 is configured to merge the differences identified at block 1010 with source descriptor 180. Processor 108 can, as part of the performance of block 1015, discard any differences which are identical to other differences already merged (this discarding of duplicates can also be conducted at block 1010). If differences conflict with each other or with source descriptor 180, processor 108 can be configured to generate an interface on display 120 from which certain differences can be selected for merging while others can be selected for discarding (or discarded as a result of not being selected).

Once the merging is complete, processor 108 can return to the performance of method 800 as described above. It is contemplated that following a merging operation at block 1015, processor 108 can also be configured to initiate a performance of blocks 230-250 of method 200 in order to propagate the data contained in the new merged version of source descriptor 180 out to any subscribing descriptors (such as 188).

Certain variations to the above system and methods are contemplated. For example, although descriptors in the form of textual password formatting requirements are discussed above, a wide variety of descriptors can be managed according to the contents of this specification. In general, a descriptor is data which place a constraint on the specifications of a proposed software application. Thus, descriptors can include any suitable combination of the textual requirements discussed above (and relating to any aspect of the proposed application, rather than only to password formatting); business process models; picture-boards; use cases; user interface mockups; actor definitions (e.g. types of users); business rules; data operations; documents; reviewer comments and business domain information.

In some embodiments, textual descriptors such as 180 and 188 can include one or more attribute/value pairs rather than a single field 308 or 408. For example, source descriptor 180 can include an attribute named “length” with an associated value of “7”.

In a further variation, block 210 of method 200 can include the receipt of a second descriptor without any initial connection to source descriptor 180. Processor 108 can be configured to compare the received descriptor to existing descriptors, and to interpret the receipt of the new descriptor as a request for source descriptor 180 if the new descriptor is identical or sufficiently similar to source descriptor 180.

In another variation, whether or not a descriptor can be a source descriptor can be defined by way of an additional field (not shown) in the descriptor data record, indicating whether or not subscription is permissible.

It is contemplated that the above-described methods can be performed for a plurality of different modules, such that descriptors from various modules are subscribed to a source descriptor in the first module, and that all subscribing descriptors can themselves act as source descriptors for further subscribing descriptors. In still another variation, rather than being stored in connection with first module 176, source descriptor 180 can be stored as part of a source descriptor library which is not connected to any module, but which descriptors in modules can subscribe to.

Those skilled in the art will appreciate that in some embodiments, the functionality of simulation application 172 as executed by processor 108 can be implemented using pre-programmed hardware or firmware elements (e.g., application specific integrated circuits (ASICs), electrically erasable programmable read-only memories (EEPROMs), etc.), or other related components.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

We claim:

1. A method, comprising:
storing a source descriptor in a memory in association with a first module, the source descriptor comprising a requirement for at least a portion of a proposed software application defined by the first module;
receiving a request for the source descriptor at a processor interconnected with the memory; and
creating and storing, responsive to receiving the request, a subscribing descriptor, the subscribing descriptor being a copy of the source descriptor and including an identifier of the source descriptor, the subscribing descriptor being stored in the memory in association with a second module.

2. The method of claim 1, further comprising:
determining that the source descriptor has been updated; and,
applying the source descriptor update to the subscribing descriptor and storing the updated subscribing descriptor in the memory.

3. The method of claim 2, further comprising:
prior to applying the source descriptor update to the subscribing descriptor, determining whether to generate a notification based on a subscription type stored in the memory in association with the subscribing descriptor;
when the determination is affirmative, controlling a display interconnected with the processor to generate a notification, and
when the determination is negative, automatically applying the source descriptor update.

4. The method of claim 3, further comprising:
in response to controlling the display to generate a notification, receiving an instruction at the processor to apply the source descriptor update.

5. The method of claim 1, further comprising:
receiving an update to the subscribing descriptor and storing the updated subscribing descriptor in the memory;
determining whether to apply the subscribing descriptor update to the source descriptor.

6. The method of claim 5, further comprising:
when the determination is affirmative, applying the subscribing descriptor update to the source descriptor and storing the updated source descriptor in the memory.

7. The method of claim 5, further comprising:
when the determination is negative, determining whether a conflict exists between the updated subscribing descriptor and the source descriptor; and
if a conflict exists, suppressing the subscription of the updated subscribing descriptor to the source descriptor.

8. The method of claim 1, wherein the second module defines at least one of a further proposed application and a different portion of the proposed application.

9. The method of claim 1, wherein the request is received at the processor from an input device interconnected with the processor.

10. A computing device, comprising:
a memory for storing a source descriptor in association with a first module, the source descriptor comprising a requirement for at least a portion of a proposed software application defined by the first module;
a processor interconnected with the memory for receiving a request for the source descriptor;
the processor configured, responsive to receiving the request, to create and store a subscribing descriptor in the memory in association with a second module, the subscribing descriptor being a copy of the source descriptor and including an identifier of the source descriptor.

11. The computing device of claim 10, the processor being further configured to determine that the source descriptor has been updated; the processor further configured to apply the source descriptor update to the subscribing descriptor and to store the updated subscribing descriptor in the memory.

12. The computing device of claim 11, further comprising:
a display interconnected with the processor and the memory;
the processor being further configured, prior to applying the source descriptor update to the subscribing descriptor, to determine whether to generate a notification based on a subscription type stored in the memory in association with the subscribing descriptor;
the processor further configured, when the determination is affirmative, to control the display to generate a notification, and when the determination is negative, to automatically apply the source descriptor update.

13. The computing device of claim 12, the processor being further configured, in response to controlling the display to generate a notification, to receive an instruction to apply the source descriptor update.

14. The computing device of claim 10, the processor being further configured:
to receive an update to the subscribing descriptor and store the updated subscribing descriptor in the memory; and
to determine whether to apply the subscribing descriptor update to the source descriptor.

15. The computing device of claim 14, the processor being further configured, when the determination is affirmative, to apply the subscribing descriptor update to the source descriptor and to store the updated source descriptor in the memory.

16. The computing device of claim 14, the processor being further configured, when the determination is negative, to determine whether a conflict exists between the updated subscribing descriptor and the source descriptor; and if a conflict exists, to suppress the subscription of the updated subscribing descriptor to the source descriptor.

17. The computing device of claim 10, wherein the second module defines at least one of a further proposed application and a different portion of the proposed application.

18. The computing device of claim 10, wherein the request is received at the processor from an input device interconnected with the processor.

19. A non-transitory computer readable medium for storing a plurality of computer readable instructions executable by a processor for performing a method comprising:
storing a source descriptor in a memory interconnected with the processor in association with a first module, the source descriptor comprising a requirement for at least a portion of a proposed software application defined by the first module;
receiving a request for the source descriptor at the processor; and
creating and storing, responsive to receiving the request, a subscribing descriptor, the subscribing descriptor being a copy of the source descriptor and including an identifier of the source descriptor, the subscribing descriptor being stored in the memory in association with a second module.
